(19) United States
(12) Patent Application Publication
(10) Pub. No.: US 2003/0058373 A1
(43) Pub. Date: Mar. 27, 2003

(54) LCD projection device

(76) Inventors: Wouter Roest, Utrecht (NL); Helmar Van Santen, Eindhoven (NL)

Correspondence Address: Michael E. Marion, U. S. Philips Corporation, 580 White Plains Road, Tarrytown, NY, 10591, US

(21) Appl. No.: 10/170,028

(22) Filed: Jun. 12, 2002

(30) Foreign Application Priority Data
Jun. 14, 2001 (EP) 01202297.6

(51) Int. Cl. G02F 1/1335

(52) U.S. Cl. 349/5

(57) ABSTRACT

An LCD projection device is adapted to receive an image signal representing an image to be projected. The device comprises a liquid crystal matrix (2, 11) and a control device (5) converting the image signal (6) into a control signal for the liquid crystal matrix (2, 11). The control device (5) comprises a look-up table (28, 34 to 37) for each pixel (14, 22, 39) of the liquid crystal matrix (2, 11). For given values of the image signal (6), the look-up table (28, 34 to 37) indicates which control signal is associated with a given value (I_{A}, I_{B}) of the image signal (6).

The invention relates to an LCD projection device adapted to receive an image signal representing an image to be projected, and comprising a liquid crystal matrix and a control device which converts the image signal into a control signal for the liquid crystal matrix.

Such an LCD projection device is known from European patent application 0 621 499. This document describes a correction mechanism by means of two retardation plates for a transmissive liquid crystal matrix.

The use of retardation plates has the drawback that the correction to be obtained therewith has the same value for the entire liquid crystal matrix.

In an LCD projection device, the angles from which the liquid crystal matrix is observed are completely fixed in advance. This is in contrast to direct vision liquid crystal displays in which the display is observed from many angles. Known problems in liquid crystal displays are loss of contrast and grey scale inversion. In projection devices as described in European patent application 0 621 499, such problems of contrast loss and image inversion also occur and such problems are partly solved in this patent application by using retardation plates. However, use of these retardation plates cannot lead to the same result for the entire image because the angles of incidence are not identical for the entire image but are dependent on the position on the image and consequently the position on the liquid crystal matrix.

It is an object of the invention to provide an LCD projection device as described in the opening paragraph, in which the above-mentioned drawback is greatly reduced.

According to the invention, this object is achieved in that the control device comprises at least one look-up table indicating for at least one pixel of the liquid crystal matrix and for at least one given value of the image signal which control signal is associated with the at least one given value of the image signal, and in that the control device is adapted to control the at least one pixel of the liquid crystal matrix in the presence of the at least one given value of the image signal for the at least one pixel by means of the control signal which, in accordance with the look-up table, is associated with the at least one given value of the image signal for the at least one pixel.

It is thereby achieved that, for each pixel, the relation between the receiving image signal and the control signal is accurately determined for the liquid crystal matrix.

A projection device according to the invention provides the possibility of determining in advance the effects of the different angles at which light is incident on the different parts of the LCD projection device, and of determining its consequences. Subsequently, it can be determined for each pixel to what extent a control signal can be modified for the relevant pixel, such that the eventually projected image is considerably closer to the image represented by the image signal than would have been possible without the relevant correction.

A preferred embodiment of an LCD projection device according to the invention is characterized in that the image signal is a digital signal and in that, for each digital value of the image signal, the look-up table has a value for the control signal.

It is thereby achieved that the most appropriate control signal for the relevant pixel is generated and applied thereto throughout the trajectory from maximally dark to maximally light.

A further preferred embodiment of an LCD projection device according to the invention is characterized in that the control device comprises a look-up table for each pixel of the liquid crystal matrix.

It is thereby achieved that the maximally achievable performance of the LCD projection device is ensured for the entire represented image to be projected.

It is known that the more an incident ray on a liquid crystal matrix deviates from the normal on the plane of the liquid crystal matrix, the larger the deviations are that must be corrected. In projection devices for projection on a screen, it is generally sufficient to use an optical system having a relatively small numerical aperture. However, for projection systems on which a virtual image is projected which can be observed with, for example, the human eye, there is often a need for a large numerical aperture. At a large numerical aperture, the deviations to be corrected are larger than at a smaller numerical aperture.

A preferred embodiment of an LCD projection device comprising an optical system whose numerical aperture may have more than one value, is characterized in that the control device comprises a look-up table for at least two values of the numerical aperture.

These and other aspects of the invention are apparent from and will be elucidated with reference to the embodiments described hereinafter.

In the drawings:

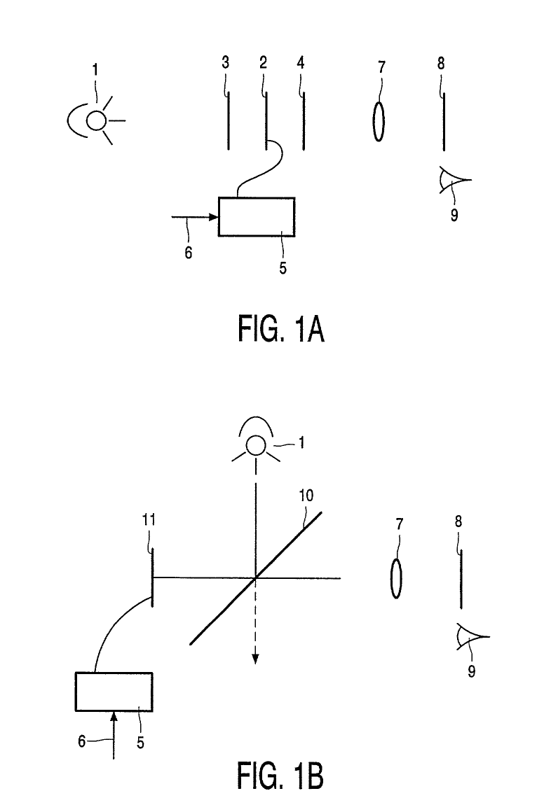

FIG. 1A shows a basic arrangement of an LCD projection device with a transmissive liquid crystal matrix;

FIG. 1B shows a basic arrangement of an LCD projection device with a reflective liquid crystal matrix;

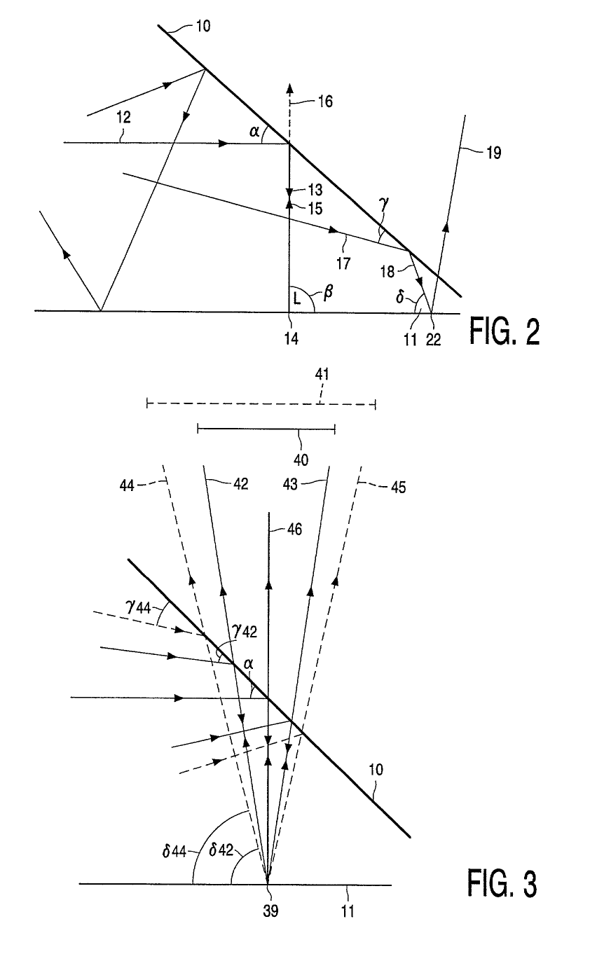

FIG. 2 shows diagrammatically different angles of incidence of light on a liquid crystal matrix;

FIG. 3 shows diagrammatically the effects resulting from the numerical aperture;

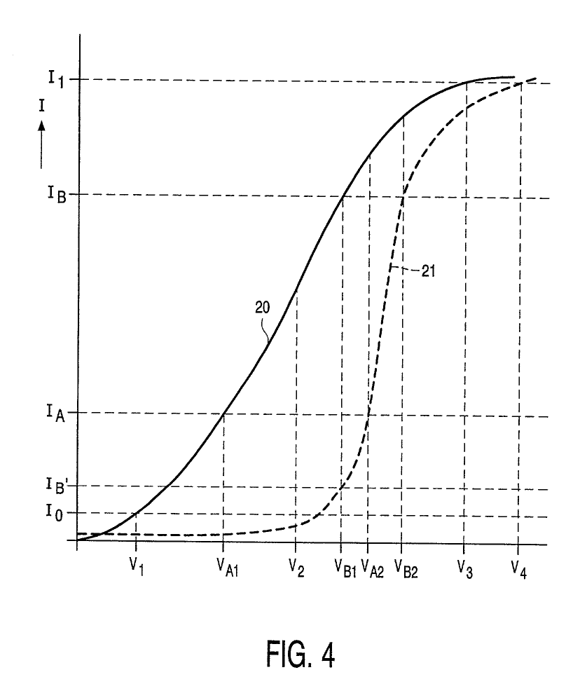

FIG. 4 shows a relationship for two different angles of incidence between the applied voltage and the intensity of transmitted/reflected light;

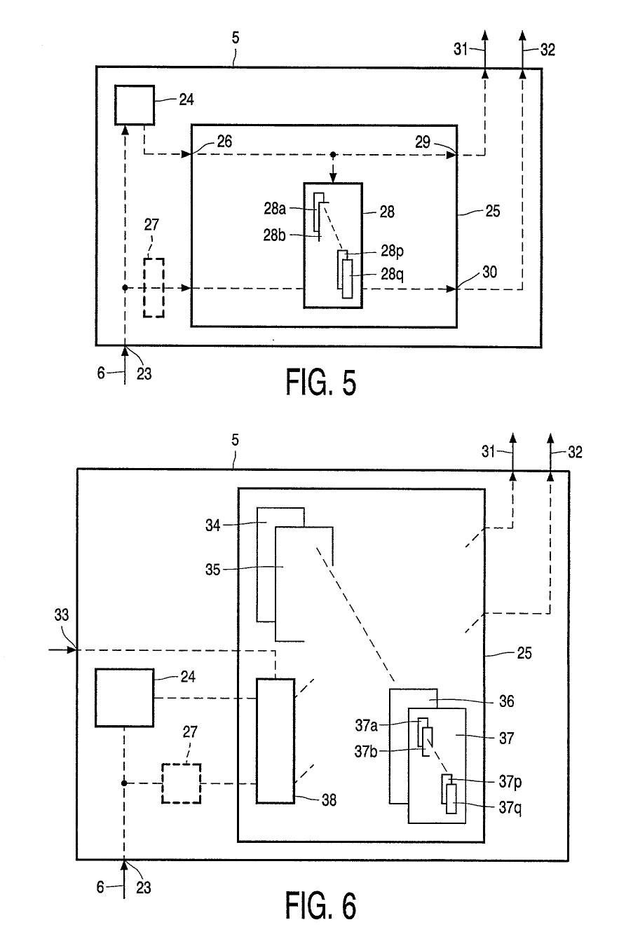

FIG. 5 shows further details of a control device in a projection device;

FIG. 6 shows further details of a control device in a projection device in which more than one numerical aperture may be present,

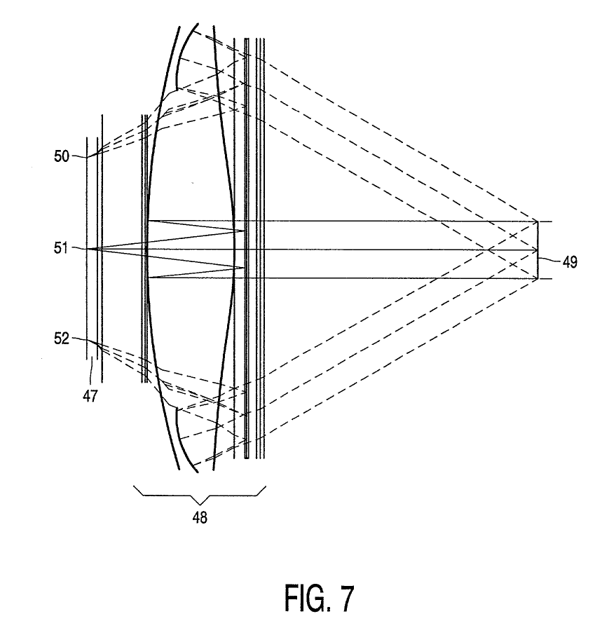

FIG. 7 shows a projection of a diagrammatically shown LCD projection device, to be used in a helmet-mounted display.

In FIG. 1A, the reference numeral 1 denotes a light source. The reference numeral 2 denotes a liquid crystal matrix which is provided with a polarizer 3 on one side and an analyzer 4 on the other side. The pixels of the liquid crystal matrix 2 are controllable by means of a control device 5. The control device 5 has an input for receiving an image signal, diagrammatically denoted by the arrow 6, which image signal represents an image to be projected. An image formed is projected by means of an optical system 7 on a screen 8, or a virtual image formed may be observed with an eye 9.

FIG. 1B shows the same LCD projection device, but now with a reflective liquid crystal matrix. Light coming from the light source 1 is incident on a polarizing semi-transmissive mirror 10 and is partly reflected towards a reflective liquid crystal matrix 11.

The reflective liquid crystal matrix 11 is controlled by a control device 5 having an input for receiving image signal 6 which represents an image to be projected. An optical system 7 projects an image of the liquid crystal matrix 11 on a screen 8 or enables an eye 9 to view the liquid crystal matrix 11.

The problems which are inherent in the LCD projection devices shown in FIGS. 1A and 1B will hereinafter be elucidated with reference to a reflective liquid crystal matrix. It should be noted that the problem occurs similarly in a transmissive liquid crystal matrix and is dealt with and solved in the same manner.

LCD projection devices are renowned for their property to illuminate an element of relatively small dimensions (approximately 1 cm) by means of a single strong light source, which element is subsequently imaged on a projection screen or viewed with a human eye. It is desirable that a maximal contrast is achieved between the highest and the lowest intensity. The highest intensity is dependent on the intensity of the light source and the lowest intensity is dependent on the fact to what extent the light from the light source does not reach the screen 8 or the eye 9. The smaller the quantity of light that can reach the screen 8 or the eye 9, the larger the observed contrast.

LCD projection devices influence the extent of rotation of polarized incident light on all pixels. A control signal for a pixel ensures that the extent of rotation is dependent on the value of the control signal which is applied by the control device 5 to the relevant pixel on the basis of a value of the image signal for the relevant pixel at the relevant instant. In the basic situation, a very large contrast can be achieved when the light coming from the light source is first polarized by means of a polarizer or the polarizing semi-transmissive mirror 10, and is subsequently transmitted through or reflected on the liquid crystal matrix 2, or 11, respectively. In FIG. 2, the basic situation is indicated by ray 12 which is incident on the polarizing semi-transmissive mirror 10 at an angle 45° and is thereby deflected through an angle of 90° to form a ray 13 in the direction of the liquid crystal matrix 11. The ray 13 is incident on a pixel of the reflective liquid crystal matrix 11 at the position 14 and is thereby reflected to a ray 15 which is subsequently passed on as ray 16 by the polarizing semi-transmissive mirror 10. Dependent on the value of the control signal applied by the control device 5 to the pixel proximate to position 14, ray 16 has the same or a lower intensity than ray 13.

Upon perpendicular incidence on the liquid crystal matrix 11 and upon incidence at an angle of 45° of ray 12 on the polarizing semi-transmissive mirror 10, it is possible to obtain ray 16 with an intensity which is substantially completely zero. This is the result of the fact that ray 13 is polarized completely linearly at an angle of incidence below 45° (angle α in FIG. 2) and that the direction of polarization of ray 13 is completely rotated through 90° to form ray 15 in the case of perpendicular incidence (angle β). In that case, ray 15 is entirely transmitted by the polarizing semi-transmissive mirror 10, to form ray 16 which then represents the highest intensity. However, upon perpendicular incidence, it is alternatively possible to apply a control signal from the control device 5 to the pixel at the position 14 so that the direction of polarization of the beam 13 is not modified at all, and the returning beam 15 will substantially not be passed or will not be passed at all by the polarizing semi-transmissive mirror 10. The result is that ray 16 has a very small intensity, or no intensity.

At angles other than α=45° and β=90°, such as the angle γ and the angle δ which are smaller than 45° and 90°, respectively, it is generally impossible to maintain, without any further measures, the contrast between the rays 18 and 19 to the same extent as is possible between the rays 13 and 16.

FIG. 4 shows diagrammatically the consequences of changing the angles α and β to the angles γ and δ. In FIG. 4, a control voltage for a pixel of the liquid crystal matrix 11 is plotted on the horizontal axis and the intensity of a ray transmitted by the semi-transmissive polarizing mirror 10 is plotted on the vertical axis. The solid-line curve 20 shows diagrammatically and by way of example the relationship between the voltage V across the pixel at the position 14 and the intensity I of the ray 16. Likewise, the broken-line curve 21 shows the same relationship for ray 19. The reference V1 denotes the control voltage at which, in accordance with curve 20, an intensity 10 of the ray 16 is obtained. V2 indicates which control voltage V2 must be present at the pixel at the position 22 so as to ensure that ray 19 has the same intensity 10 as ray 16. Similarly, V3 indicates the voltage at which ray 16 reaches the maximum intensity 11, and V4 indicates the same for ray 19. It is therefore evident from FIG. 4 that the control voltage for a pixel, at which a ray is perpendicularly incident, can be controlled from a lowest voltage V1 to a highest voltage V3, whereas for a pixel in which the incident ray is obliquely incident, such as ray 18, the same intensity range 10-11 is achieved with a control voltage in the V2-V4 range. It is not only apparent from FIG. 4 that the V1-V3 range is different from the V2-V4 range, but the length of one range is also unequal to the length of the other range, and the slope of the curve 20 differs from the slope of the curve 21.

The consequences for control are clearly apparent when the control signals required for obtaining an intensity IA and IB in accordance with curves 20 and 21 are considered. In accordance with curve 20, the relevant intensities are reached at voltages V_{A1}, and V_{B1}, and for curve 21 at V_{A2} and V_{B2}. If a pixel at the position where curve 21 applies were controlled with V_{A1} and V_{B1}, this would have the result that the intensities would be smaller than I0, or would have a value I′B, both of which intensities are much lower than the desired intensities I_{A} and I_{B}.

The situation depicted in FIG. 2, in which the angles γ and δ deviate considerably from the angles α and δ, particularly occurs proximate to the edges of the liquid crystal matrix 11. The more towards the center of the liquid crystal matrix 11, the more the angle γ is equal to the angle α and the angle δ is equal to the angle β. The situation in which the central ray, such as 13, of a beam is perpendicularly incident at the position 14, occurs frequently. However, it is alternatively possible that the optical system 7 is not placed right above the liquid crystal matrix 11. In such a case, it will not be a central ray that is perpendicularly incident on the liquid crystal matrix 11 but rather a ray which is nearer to the border of the beam. To largely eliminate the effects resulting from the fact that the rays 17 and 18 are not incident at the angles α and β on the liquid crystal matrix 11, the control device of a device according to the invention is formed in the way as is shown diagrammatically in FIG. 5.

The control device 5 shown in FIG. 5 has an input 23 for an image signal 6. The input 23 is connected to a pixel-defining circuit 24 and to an image signal input of a conversion circuit 25. An address output of the circuit 24 is connected to an address input 26 of the conversion circuit 25. When the image signal 6 is an analog signal, an A/D converter 27 may be arranged between input 23 and the image signal input of the conversion circuit 25.

The conversion circuit 25 comprises a look-up table 28. An address input of the look-up table 28 is connected to the input 26, and a signal input of the look-up table 28 is connected to the image signal input of the conversion circuit 25. An address output 29 of the conversion circuit 25 is connected to an address output 31 of the control device 5. A control signal output of the look-up table 28 is connected to a control signal output 30 of the conversion circuit 25 which is further connected to a control signal output 32 of the control device 5. The signals at the outputs 31 and 32 of the control device 5 are connected in known manner to the liquid crystal matrix 2, 11, respectively.

By way of example, the operation of the control device 5 with a look-up table 28 will be elucidated with reference to FIG. 4 for obtaining a light intensity I_{A}, both for a pixel near 14 and for a pixel near 22.

The image signal 6 for a pixel near 14 has such a value that ray 16 has an intensity I_{A}. To this end, address information which may be present in the image signal, which address information may also originate from another means) will ensure that the address of the relevant pixel is set at the address input 26 by the pixel-defining circuit 24. The address of the relevant pixel ensures that one specific table among the tables 28a, 28b, . . . , 28p, 28q is activated in the look-up table 28. Each table 28a, 28b, . . . , 28p, 28q is associated with one pixel, or with a plurality of optically identical pixels of the liquid crystal matrix 2, 11, respectively. Each table 28a, 28b, . . . , 28p, 28q comprises the associated control voltage signal value V for the associated pixel for each image signal value, corresponding to an intensity value I. This means that, if the image signal 6 corresponds to an intensity I_{A}, a table, for example 28b, corresponding to a pixel near 14 ensures that a control signal having a value V_{A1} is set at output 30 for obtaining the relevant intensity. However, an image signal 6 corresponding to the same intensity I_{A} in another table, for example 28p, corresponding to a pixel near 22 will lead to a control voltage signal V_{A2} at output 30 and hence at output 32, simultaneously with an addressing at output 31 indicated by the relevant pixel near 22.

In the manner described above, a value of the control signal at the outputs 30, 32 is incorporated in a table 28a, 28b, . . . , 28p, 28q in the look-up table 28 for each pixel at any occurring value of the intensity, represented by the image signal 6.

In this way, the value of the control signal to be supplied by the control device 5 can be defined with great accuracy for each pixel, which gives rise to an arbitrary desired intensity for an arbitrary pixel.

In the foregoing, a control signal having a given value of the voltage was described. It should be noted that there are also digital displays. Instead of an analog control voltage, a digital value is applied to such a digital display, which value is converted in the display into a corresponding voltage. Where a control signal with a voltage value was and will be dealt with in the foregoing and in the following description, the digital value which must be supplied to a digital display is also included.

A second aspect of an LCD projection device, which can be handled in the manner described above, is that of the numerical aperture of the optical system 7. The description above is correct for the case where the optical system 7 has a numerical aperture approaching zero, so that in FIG. 2 it is sufficient for each pixel of the liquid crystal matrix 11 to draw one light ray. In practice, the numerical aperture of the optical system is unequal to zero and some times even considerably different therefrom. This means that a cone-shaped beam leaves each pixel of the liquid crystal matrix 2, 11 which beam is united to a single spot by the optical system 7. FIG. 3 again shows by way of example the situation for a reflective liquid crystal matrix 11, but the problem set and its solution are the same as for a transmissive liquid crystal matrix 2.

The pixel denoted by the reference numeral 39 in FIG. 3 is projected by means of the optical system 7. FIG. 3 shows two situations. The first situation is shown by way of a solid line and relates to the situation where the optical system 7 has a small numerical aperture, diagrammatically shown by means of solid line 40. The second situation is shown with a broken line and relates to the situation where the optical system 7 has a large numerical aperture, which is diagrammatically shown by means of broken line 41.

All rays leaving pixel 39 and falling within the border rays 42 and 43 shown in FIG. 3 (in the case of optical system 7 with a small aperture) will lead to a noticeable image formation by the optical system 7. The rays 42 and 43 constitute the cross-section of the plane of the drawing, with the outer wall of the cone-shaped beam of all rays leaving the pixel denoted by reference numeral 39. In this case, the rays 44 and 45 do not play a role. However, when the optical system 7 has a larger numerical aperture, for example, as shown by means of broken line 41, all rays between the rays 44 and 45, hence also rays 42 and 43, will play a role in the formation of the image by the optical system 7. It will be evident from FIG. 3 that the larger the numerical aperture, the more rays will be included in the cone-shaped beam for which the angle between the incident ray and the plane of the polarizing semi-transmissive mirror 10 will deviate from the angle α (see FIG. 2), and the larger the maximum value of the deviation. In FIG. 3, angle γ 42 deviates less from angle α than angle γ 44. The same applies to the angle between the incident/reflected ray from pixel 39. The angle δ 42 deviates less from 90° than the angle δ 44. The problem caused by a larger numerical aperture will become more manifest near the edges of the liquid crystal matrix 11 rather than in its center.

Corrections to be performed as are indicated, for example, by the curves 20 and 21 in FIG. 4, will therefore not only take into account the effect of the oblique incidence for each pixel (angle δ in FIG. 2) of a central ray (as shown in FIG. 2) of a cone-shaped beam, but also the oblique (and sometimes perpendicular) incidence of other rays (as shown in FIG. 3) of this cone-shaped beam. A curve 20 or 21 shown in FIG. 4 is therefore most correct for a given value of the numerical aperture of the optical system 7. For the same pixel, for which, for example, curve 20 is shown, a different curve may be associated with a different value of the numerical aperture of the optical system 7.

In one and the same projection device which can operate with lenses of different focal lengths or can be built into projectors, in which the decision which optical system and which numerical aperture will be built in is not taken until the production of the projector, or in which an optical system with an adjustable numerical aperture and/or focal length (zoom optics) will be built in, it is advisable to have a control device which has been prepared for such a situation.

Such a control device is shown diagrammatically in FIG. 6 in which components which are identical to those in FIG. 5 are denoted by the same reference numerals and will not be further described. The control device of FIG. 6 has an input for a signal 33, which signal 33 represents the numerical aperture of the optical system in the LCD projection device. The signal 33 is applied to a selector switch 38 which applies the signals from the address signal generator 24 and from the input 23 to one of a number of look-up tables 34, 35, . . . , 36, 37. Each look-up table 34 to 37 is entirely comparable with the look-up table 28 described with reference to FIG. 5. Look-up table 34 is associated with a first numerical aperture, table 35 is associated with a second numerical aperture, and so forth. Look-up table 37 also includes tables 37a, 37b, . . . , 37p, 37q which completely correspond to the tables 28a, 28b, . . . , 28p and 28q in FIG. 5. The switch 38 also ensures that the relevant look-up table is connected to the outputs 31 and 32.

In the foregoing, the control signal value which must be available at the output 32 and is incorporated in the relevant look-up table is described with reference to the look-up tables 28, 34 to 47. It should be noted that the look-up tables 28, 34 to 37 may also be filled with values differing from a standard value instead of the signal values that must appear at the output 32. The standard value could be formed, for example, by the values V1, V_{A1}, V_{B1}, V3, etc., corresponding to curve 20 in FIG. 4. For each intensity I, the difference value could then be incorporated together with the relevant standard value in the look-up tables 28, 34 to 37. Referring to FIG. 4, this would mean, for example, that the value V2−V1 is incorporated for the intensity 10 in look-up table 28, the value V_{A2}−V_{A1} for I_{A}, and so forth.

In the control device 5, the conversion circuit 25 constitutes a separate unit incorporating the look-up table 28 as a further separate unit. The same applies to the look-up tables 34 to 37. The look-up tables 28, 34 to 37 are incorporated in a memory which permanently or not permanently forms part of the conversion circuit 25. In the case where the memory with the look-up table 28 or the memory with the look-up tables 34 to 37 does not permanently form part of the conversion circuit 25, the memory may be exchangeable. From a production-technical point of view, this is important because many types of LCD projection devices can be randomly manufactured in one and the same production process in this way, in which process it should only be ensured that the correct memory with a correct look-up table is placed in a projection device comprising the optical system associated with this lookup table.

FIG. 7 shows an LCD projection system with a liquid crystal matrix 47, an optical system 48 and a pupil 49 of an observation means such as the human eye. Three times three lines are drawn from the pupil 49, which lines indicate three different viewing directions for the eye. Each viewing direction ends at a pixel 50, 51, 52 of the liquid crystal matrix 47 via the optical system 48. The three lines from each pixel, consisting of a central line and two border lines, clearly show the effect of the aperture 49: the smaller the aperture 49, the closer the two border lines are located near the central line. It is also clearly visible that the central lines extend at different angles to the liquid crystal matrix 47, which causes the effects extensively described with reference to FIG. 2.

It will be evident that many embodiments and modifications can be conceived by those skilled in the art. All of these embodiments and modifications are considered to be within the scope of the present invention.

1. An LCD projection device adapted to receive an image signal (6) representing an image to be projected, and comprising a liquid crystal matrix (2, 11) and a control device (5) which converts the image signal (6) into a control signal for the liquid crystal matrix (2, 11), characterized in that the control device (5) comprises at least one look-up table (28, 34 to 37) indicating for at least one pixel (14, 22, 39) of the liquid crystal matrix (2, 11) and for at least one given value (I_{A}, I_{B}) of the image signal (6) which control signal is associated with the at least one given value (I_{A}, I_{B}) of the image signal (6), and in that the control device (5) is adapted to control the at least one pixel (14, 22, 39) of the liquid crystal matrix (2, 11) in the presence of the at least one given value (I_{A}, I_{B}) of the image signal (6) for the at least one pixel (14, 22, 39) by means of the control signal which, in accordance with the look-up table (28, 34 to 37) is associated with at least one given value (I_{A}, I_{B}) of the image signal (6) for the at least one pixel (14, 22, 39).

2. An LCD projection device as claimed in claim 1, characterized in that the image signal (6) is a digital signal.

3. An LCD projection device as claimed in claim 1, characterized in that the image signal (6) is an analog signal, and in that an A/D converter (27) is provided for converting the analog image signal into a digital image signal.

4. An LCD projection device as claimed in claim 2 or 3, characterized in that the look-up table (28, 34 to 37) has a value for the control signal for each digital value of the image signal (6).

5. An LCD projection device as claimed in any one of claims 1 to 4, characterized in that the control device (5) comprises more than one look-up table (28, 34 to 37).

6. An LCD projection device as claimed in claim 5, characterized in that the control device (5) comprises a look-up table (28a, 28b, 28p, 28q, 37a, 37b, 37p, 37q) for each pixel of the liquid crystal matrix (2, 11).

7. An LCD projection device as claimed in claim 5 or 6, comprising an optical system (7) whose numerical aperture may have more than one value, characterized in that the control device (5) comprises a look-up table (34 to 37) as claimed in any one of claims 1 to 4 for at least two values of the numerical aperture.

8. A control device for an LCD projection device as claimed in any one of the preceding claims, characterized in that the control device (5) is provided with a memory (28, 34 to 37) comprising at least one look-up table (28, 34 to 37) as claimed in any one of the preceding claims.

9. A control device as claimed in claim 8, characterized in that the memory (28, 34 to 37) is exchangeable.

10. An exchangeable memory (28, 34 to 37) as claimed in claim 9.
